(19) United States
(12) Patent Application Publication
(10) Pub. No.: US 2007/0106026 A1
(43) Pub. Date: May 10, 2007

(54) Fluoropolymer composition for melt processing

(76) Inventor: Shinichi Namura, Shizuoka-City (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/592,519

(22) Filed: Nov. 3, 2006

(30) Foreign Application Priority Data
Nov. 8, 2005 (JP) 2005-323636

(51) Int. Cl. C08L 27/12

(52) U.S. Cl. 525/199

(57) ABSTRACT

A composition having excellent resistance to chemical permeation, comprising (A) a tetrafluoroethylene-perfluoro(alkyl vinyl ether) copolymer, (B) a melt-flowable polytetrafluoroethylene directly obtained by the polymerization of tetrafluoroethylene, and (C) a polytetrafluoroethylene with a low molecular weight obtained by the radiolysis of a non-melt flowable polytetrafluoroethylene with a high molecular weight; the weight ratio of A/(B+C) is 80/20 to 30/70; and the weight ratio of (A+B)/C is 99.99/0.01 to 90/10.

### FIELD OF INVENTION

The present invention pertains to a fluoropolymer composition for melt processing having excellent resistance to chemical permeation.

### BACKGROUND OF THE INVENTION

PFA, the copolymer of tetrafluoroethylene (TFE) and perfluoro(alkyl vinyl ether) (PAVE) has excellent resistance to heat and chemicals. PFA is used for melt molding of articles such as pipes for transporting various types of chemical solutions, fitting of the pipes, in making or lining pipes, fittings, valves, transportation containers, storage containers, pumps, and filter housings used in the pharmaceutical industry, and in other processes such as chemical plants, and semiconductor manufacturing process or liquid crystal manufacturing process; and for lining of articles such as steel pipes, valves and fittings.

In these applications, PFA is exposed to highly permeable chemicals such as sulfuric acid, hydrochloric acid, hydrofluoric acid, nitric acid, ammonia, their mixtures with hydrogen peroxide or ozone, developing or peeling solutions for photoresist to which a fluorinated surfactant is added, high-concentration ozone vapor, and ozone water. To suppress the corrosion of the equipment and the generation of cracks of molded articles due to permeation of these chemicals, PFA having high durability, as measured by flex life (sometimes called MIT flex life) and improved resistance to chemical permeation is desired. Nitrogen gas permeability is ordinarily used as a convenient measure to evaluate the permeability of PFA. Typical permeability of commercial PFA to nitrogen gas has been 0.8-1.2×10⁻¹⁰ cm³ (STP)·cm/cm²·sec·cmHg.

In Japanese Kokai Patent Application No. 2002-167488 U.S. Pat. No. 6,649,699, the permeation resistance of PFA is improved, by blending PFA with polytetrafluoroethylene (PTFE) having low molecular weight. It is reported that the permeation resistance is improved with the increase of the PTFE mixture ratio. The low molecular weight PTFE is either a melt-flowable PTFE directly obtained by the polymerization of the PTFE, or a PTFE which is obtained by the thermal decomposition or radiolysis of high molecular weight (non-melt processible) PTFE. In particular, since the low molecular weight PTFE obtained by direct polymerization is preferably blended with PFA because it is less costly, than the low molecular weight PTFE obtained by special treatments such as radiolysis, and furthermore has excellent thermal stability, and is more easily obtained in high purity, it is preferable for blending with the PFA. However, even if the amount of the blended PTFE is increased to a level of 20% or greater of the PFA plus PTFE composition, the improvement of the permeation resistance of the composition does not increase in proportion to the increase of the PTFE content. The purpose of the present invention is to provide an improved composition composed of PFA and a melt-flowable PTFE directly obtained by the polymerization having improved resistance to chemical permeation.

### SUMMARY OF THE INVENTION

The fluoropolymer composition for melt processing of the present invention is composed of three components of (A) PFA, (B) melt-flowable PTFE directly obtained by polymerizing TFE, and (C) PTFE with a low molecular weight obtained by the radiolysis of a non-melt flowable high molecular weight PTFE. The weight ratio of A/(B+C) ranges from 80/20 to 30/70, and the weight ratio of (A+B)/C ranges from 99.99/0.01 to 90/10.

The composition of the present invention has improved permeation resistance, compared with a composition composed of two components of PFA (A) and PTFE. It is found surprisingly that there is a synergistic effect of PTFE (B) and PTFE (C), that is greater than the effect of either type of PTFE alone in a blend with PFA. Furthermore, small amounts of PTFE (C) as compared to PTFE (B) are effective in reducing permeability. PFA (A) and PTFE (B) even with small amounts of PTFE (C), have low nitrogen gas permeability of 0.7×10⁻¹⁰ cm³ (STP)·cm/cm²·sec·cm Hg or less, compared with commercial PFA.

### BRIEF DESCRIPTION OF THE FIGURE

FIG. 1 shows the apparatus used in a hydrochloric acid permeation test.

### DETAILED DESCRIPTION OF THE INVENTION

The PFA (A) of the present invention is a copolymer of TFE and PAVE that can be manufactured by conventional methods such as solution polymerization, emulsion polymerization, or suspension polymerization. PAVE used in the copolymer can be that of Formula 1 or 2. Examples include copolymers of TFE with perfluoro(methyl vinyl ether) (PMVE). This polymer, sometimes referred to as MFA, usually includes some PPVE in addition to PMVE. Preferred comonomers are perfluoro(propyl vinyl ether) (PPVE) and perfluoro(ethyl vinyl ether) (PEVE), of which the PEVE is the more preferred comonomer.

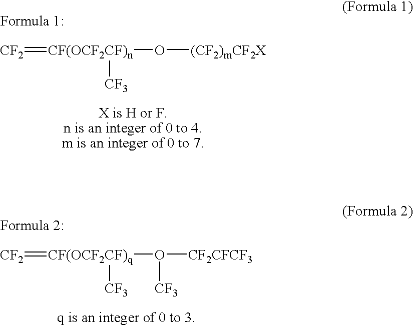

In the present invention, the PAVE content in the PFA (A) is preferably 3 wt % or greater of the total wt % of PFA. If the content is less than 3 wt %, the durability of the composition obtained by mixing PTFE is unsatisfactory. The lower limit of the PAVE content is preferably 5 wt % of the total PFA wt %. In general, with the increase of the content, the durability of the composition is improved. If the PAVE content is greater than 20 wt %, high-temperature mechanical properties of the molded product deteriorate. The preferable upper limit of the PAVE content is 15 wt %, and more preferably 10 wt % of the total PFA wt %.

It is preferable for the PFA (A) used in the present invention to have a melt flow rate (hereinafter, abbreviated to MFR) of 0.01 g/10 min or greater. The lower the MFR, the greater the durability of articles made from the composition. If the MFR is less than 0.01 g/10 min, it is difficult to melt-process the composition. The preferred lower limit of the MFR is 0.05 g/10 min. The upper limit of the MFR that can maintain a good durability is 100 g/10 min, preferably 70 g/10 min, and more preferably 40 g/10 min. PFA with an MFR of less than 0.01 g/10 min and PFA with an MFR of greater than 0.01 g/10 min can also be mixed to adjust the MFR between the above-mentioned upper limit and lower limit.

In the present invention, the PTFE (B) and the PTFE (C) are mixed with the above-mentioned PFA (A). Both the PTFE (B) and (C) are TFE homopolymer or a modified PTFE containing 1 wt % or less of a comonomer such as hexafluoropropylene, perfluoro(alkyl vinyl ether), fluoroalkylethylene, or chlorofluoroethylene.

The PTFE (B) is a melt-flowable PTFE (that is, the melt flow rate can be measured by the method described in the Examples) directly obtained by polymerization of TFE without depending on treatments such as thermal decomposition or radiolysis, and has an MFR of 1 g/10 min or greater, preferably 5 g/10 min or greater. If the MFR is less than 1 g/10 min, the moldability of the composition is reduced. The upper limit of the MFR is not particularly limited but is usually selected from a range of 1,000 g/10 min or less. PTFE (B) can be manufactured by conventional methods such as solvent polymerization, emulsion polymerization, and suspension polymerization of TFE. U.S. Pat. Nos. 3,067,262 and 6,060,167, Japanese Kokoku Patent No. Sho 57 [1982]-22043, and U.S. Pat. No. 5,789,504, disclose such methods.

PTFE (C) is a PTFE with a low molecular weight obtained by radiolysis of a non-melt flowable PTFE of high molecular weight. Such non-melt flowable PTFE is often called “molding powder” or “fine powder.” Since the melt flowablity increases with decreasing molecular weight of the PTFE, the extent of decrease of the molecular weight can be monitored by measuring the MFR of the PTFE as a function of degree of irradiation. The PTFE (C) in the present invention has an MFR of 0.01g/10 min or greater, and preferably 0.1 g/10 min or greater. If the MFR is less than 0.01 g/10 min, uniform dispersion of the PTFE in the composition is difficult. The upper limit of the MFR is not particularly limited but is preferably in the range of 1,000 g/10 min or less. The PTFE (C) can be manufactured by irradiation with gamma rays or an electron beam of the above-mentioned “molding powder” or “fine powder” at a temperature lower than the melting temperature under vacuum or in air or in an inert gas atmosphere until the radiation dose reaches 10 kGy-1 MGy. The reaction is disclosed in Japanese Kokoku Patent Nos. Sho 47 [1972]-19609, Sho 52 [1977]-38870, and GB 1,406,238.

The size of the PTFE (B) and the PTFE (C) particles are not particularly limited, and a powder with an average particle diameter of 0.01-100 μm can be used. A uniform composition is more easily obtained if the average particle diameter is preferably 0.05-50 μm, and more preferably 0.05-25 μm.

The above-mentioned PFA (A), PTFE (B), and PTFE (C) of the composition of the present invention, are mixed in the weight ratio of A/(B+C) ranging from 80/20 to 30/70, and preferably ranging from 80/20 to 40/60, and more preferably ranging from 80/20 to 50/50. If the content of (B+C) is less than 20 wt %, the improvement of the permeation resistance is small, and if the content is more than 70 wt %, durability and mechanical strength of the composition decrease.

The composition of the present invention in which the PTFE component is composed of (B) and (C) has a permeation resistance improved by 20% or more compared to the permeation of PFA itself. If the ratio (A+B ) to C is in the range of 99.99/0.01 to 90/10 as the weight ratio of the PTFE (C), a sufficient improvement effect is obtained. If the ratio is less than 0.01 wt %, significant improvement in permeation resistance is not observed. The mixture ratio of more than 10 wt % tends to decrease the durability of the composition. The (A+B)/C weight ratio is preferably 99.9/0.1 to 95/5, and more preferably 99/1 to 95/5.

The composition composed of the above-mentioned PFA (A), PTFE (B), and PTFE (C) of the present invention can be melt processed and has an MFR of 0.1-100 g/10 min. If the MFR is less than 0.1 g/10 min, melt processing is difficult. If it is more than 100 g/10 min, the durability of the composition is unsatisfactory. The MFR is preferably 0.5-50 g/10 min. The MFR of the composition can be estimated using the following equation.
(1/MFR of the composition)^{1/3.4}=(weight % of PFA (A)) (1/MFR of PFA (A))^{1/3.4}+(weight % of PTFE (B)) (1/MFR of PTFE (B))^{1/3.4}+(weight % of PTFE (C))(1/MFR of PTFE (C))^{1/3.4}.

However, since the MFR of the composition sometimes deviates slightly from the numerical value obtained using the above-mentioned relation equation because of thermal decomposition or coupling phenomenon of the polymers during mixing or such post-treatments as fluorination, the MFR of the PFA (A), the PTFE (B), and the PTFE (C) can be estimated by taking this variation into consideration so that the MFR of the final composition will be in the desired range.

In the manufacture of the composition of the present invention, if the PTFE is not well mixed, durability of articles made from the composition will be reduced. Therefore it is preferable to charge the PFA (A), the PTFE (B), and the PTFE (C) into a batch type or continuous kneader or coaxial extruder and to uniformly melt-knead the ingredients. The PFA and PTFE powders can also be mixed in advance by dry or wet blending before melt-kneading. By wet blending is meant the mixing of dispersions of the PFA and one or both of the PTFEs. These dispersions may be the dispersions obtained by aqueous dispersion polymerization of PFA and the PTFE made by polymerizing TFE to the desired low molecular weight, or the dispersions may be made from the polymer in powder form by dispersing the powder in preferably aqueous medium with a dispersing agent, such as a surfactant. After blending, the polymers are isolated from the dispersion medium.

Also, the mixture can be obtained by adding the PTFE (B) and PTFE (C) to a polymerization medium in a polymerization vessel in advance and initiating the polymerization of TFE and PAVE to make PFA (A). Alternatively, the PTFE (C) can be mixed with a powder of core/shell construction, which is obtained by adding particles of the PFA (A) to a polymerization medium in advance and initiating polymerization of the PTFE (B).

In the present invention, the PFA and the PTFE are preferably fluorinated before or after melt-kneading by the method described in U.S. Pat. No. 4,743,658 and thereby reduce unstable end groups, to reduce the elution of fluorine ions, or to the improve the ozone resistance of articles made from the composition.

According to the present invention, an improved resistance to chemical permeation can be obtained by mixing only a small amount of the higher cost PTFE (C) in addition to the PTFE (B), so that the cost penalty is minimized. Also, since the PTFE has excellent heat resistance, chemical resistance, and purity similarly to that of the PFA, the composition of the present invention is suitable for a melt fabrication of parts for transferring various chemical solutions used in manufacturing processes of products such as chemicals, semiconductors and liquid crystal polymers. Examples of articles made from the composition of the present invention include tubes, pipes, hoses, films, sheets, round bars, and square rods by extrusion; moldings, fittings, filter housings, valves, pumps, containers, wafer carriers, vessels, tanks, flow meters by injection molding; containers such as bottles by blow molding or rotation molding; lining of valves, pumps, pipes, joints, by transfer molding; lining of steel, such as steel containers, tanks, pipes, by rotation molding; and sheets, by compression molding.

### EXAMPLES

In the Examples and Comparative Examples explained below, a copolymer of TFE and PEVE obtained by the method described in U.S. Pat. No. 5,760,151 is used as the PFA for making the compositions.

Properties were measured by the following methods:
PAVE content: A sample was melt compressed at 350° C. and cooled with water, so that a film with a thickness of about 50 μm was obtained. From the infrared absorption spectrum (in nitrogen atmosphere) of the film, the PAVE content was determined according to the method described in U.S. Pat. No. 5,760,151.
Melt flow rate (MFR): Using a melt indexer (made by Toyo Seiki Co., Ltd.) equipped with corrosion-resistant cylinder, die, and piston according to ASTM D1238-95, a 5 g sample was filled in the cylinder held at 372±1° C. The sample was held for 5 min, and extruded through the die orifice under a load (piston and weight) of 5 kg. The extrusion rate of the melt (g/10 min) was measured and reported as the MFR.
Nitrogen gas permeability: A film with a thickness of 0.25-0.35 mm prepared by a compression molding at 350° C. was used for measuring the permeability at a temperature of 23° C. by an S-69 type gas and water vapor permeability measurement device made by Shibata Kagaku Kikai K.K.

### Comparative Example 1 and Examples 1, 2, and 3

Ingredients

PFA (A): is PFA powder having an MFR of 1.5 g/10 min, PEVE content of 6.1 wt %, nitrogen gas permeability of 1.13×10⁻¹⁰ cm³ (STP)·cm/cm²·sec·cmHg;
PTFE (B): is PTFE powder (Zonyl® MP1600N made by Du Pont Co.) with an MFR of 20 g/10 min manufactured by a direct polymerization;
PTFE (C): is PTFE powder (trade name: TLP made by DuPont-Mitsui Fluorochemicals Co., Ltd.) with an MFR of 0.4 g/10 min manufactured by radiolysis of a non-melt flowable PTFE having a high molecular weight.

The above ingredients were blended by melt-kneading them at 360° C. and 30 RPM for 10 min using a Plastomill (RH60 type) made by Toyo Seiki Co., Ltd. In these Examples, the weight ratio of A/(B+C) was set to 50/50, and the weight ratio of (A+B)/C was set to 100/0, 98.5/1.5, 95/5, and 90/10. The properties of each composition are summarized in Table I.

### Comparative Example 2

90 parts by weight of the PFA (A) used in Example 1 and 10 parts by weight of the PTFE (C) used in Example 1 were melt-kneaded similarly to Example 1, so that a composition was obtained. The properties of the composition are summarized in Table I. It can be seen that the combination of PTFE (B) and PTFE (C) reduces permeability to a greater extent that either of the PTFEs when used alone. This synergism is such that most of the benefit is obtained with even a small amount of PTFE (C). Further addition of PTFE (C) provides smaller incremental improvement.

TABLE 1

| | | Comparative | | | | Comparative |
|---|---|---|---|---|---|---|
| | | Example 1 | Example 1 | Example 2 | Example 3 | Example 2 |
| Amount | PFA (A) | 50 | 50 | 50 | 50 | 90 |
| mixed (part | PTFE (B) | 50 | 48.5 | 45 | 40 | 0 |
| by weight) | FPFE (C) | 0 | 1.5 | 5 | 10 | 10 |
| Properties of | MFR (g/10 min) | 4.8 | 40 | 3.4 | 2.8 | 1.4 |
| composition | Nitrogen gas | 0.55 × 10⁻¹⁰ | 0.40 × 10⁻¹⁰ | 0.42 × 10⁻¹⁰ | 0.38 × 10⁻¹⁰ | 0.83 × 10⁻¹⁰ |
| | permeability, | | | | | |
| | cm³ (STP) · cm/cm² · | | | | | |
| | sec · cmHg | | | | | |

### Comparative Example 3 and Example 4

Using the PFA (A), the PTFE (B), and the PTFE (C) of Example 1, the weight ratio of A/(B+C) was set to 40/60, and the weight ratio of (A+B)/C was set to 100/0 and 98.5/1.5. Compositions are obtained by melt-kneading similarly to Example 1. The properties of the compositions are summarized in Table II. As in Table 1, there is a large synergistic effect of a small amount of PTFE (C) with PTFE (B) on permeation.

TABLE 2

| | | Comparative | |
|---|---|---|---|
| | | Example 3 | Example 4 |
| Amount mixed | PFA (A) | 40 | 40 |
| (part by | PTFE (B) | 60 | 58.5 |
| weight) | PTFE (C) | 0 | 1.5 |
| Properties of | MFR (g/10 min) | 5.8 | 5.2 |
| composition | Nitrogen gas permeability, | 0.51 × 10⁻¹⁰ | 0.34 × 10⁻¹⁰ |
| | cm³ (STP) · cm/cm² · | | |
| | sec · cmHg | | |

### Hydrochloric Acid Permeation

Samples from commercial PFA with an MFR of 1.9 g/10 min and a nitrogen gas permeability of 1.08×10⁻¹⁰ cm3 (STP)·cm/cm2·sec·cmHg and from the composition of Example 4, were prepared as disk-shaped sheets with a thickness of 1 mm and a diameter of 77 mm by melt compression molding at 350° C.

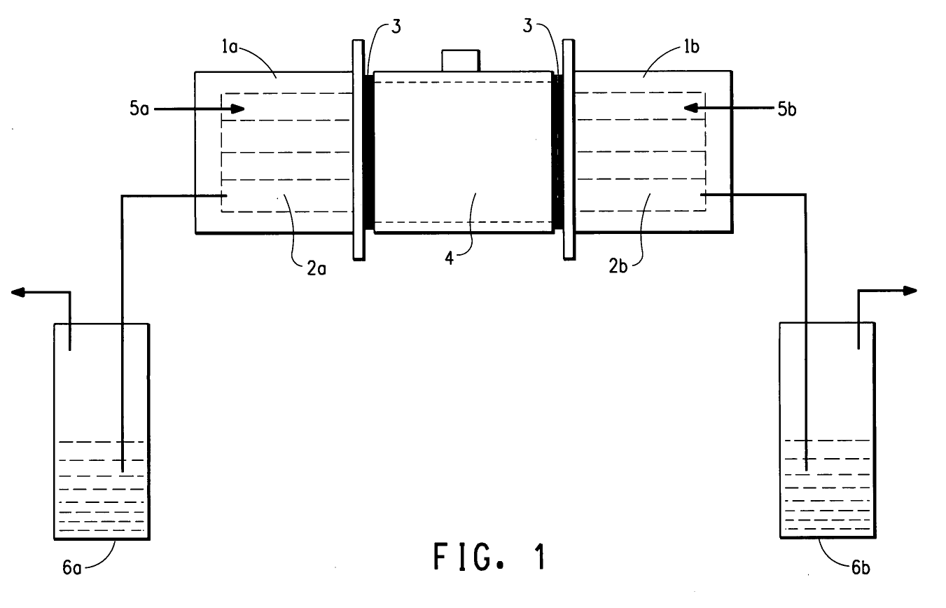

Reference is made to FIG. 1, where these sheets 2a, 2b were sandwiched between cylinder 4 made of PTFE and container 1a and 1b made of PTFE with an inner diameter of 64 mm shown in FIG. 1 via O-ring 3 made of a fluorine rubber and fastened, 60 mL 35% hydrochloric acid was put into the central cylinder 4 (a volume of 120 mL), and the cylinder part was heated to 70° C. by a heater. Air 5a, 5b was fed to the PTFE containers 1a and 1b, and the hydrochloric acid gas permeating through the sheets was trapped by trap bins 6a and 6b containing 300 mL pure water was put. Every three days, the chloride concentration (ppm) in the pure water was measured by an ion chromatography, and the amount of hydrochloric acid permeation was calculated using the following equation.
Hydrochloric acid permeation (unit: μg·mm/cm2)=chloride concentration×300×1/(3.22×3.14)

This test was continued for 30 days. The total amount of hydrochloric acid permeated is summarized in Table Ill. The superior resistance of the Composition of Example 4 to hydrochloric acid permeation is clear.

TABLE 3

| | Sample | |
|---|---|---|
| | Commercial | Composition of |
| | PFA | Example 4 |
| Nitrogen gas permeability, | 1.08 × 10⁻¹⁰ | 0.34 × 10⁻¹⁰ |
| cm³ (STP) · cm/cm² · sec · cmHg | | |
| Total amount of hydrochloric acid | 3.13 × 10³ | 0.90 × 10³ |
| permeated (30 days) (μg · mm/cm²) | | |

What is claimed is:

1. A fluoropolymer composition for melt processing, comprising (A) a tetrafluoroethylene/perfluoro(alkyl vinyl ether) copolymer, (B) a melt-flowable polytetrafluoroethylene directly obtained by polymerization of tetrafluoroethylene, and (C) a polytetrafluoroethylene with a low molecular weight obtained by radiolysis of a non-melt flowable polytetrafluoroethylene with a high molecular weight; the weight ratio of A/(B+C) ranges from 80/20 to 30/70; and the weight ratio of (A+B)/C ranges from 99.99/0.01 to 90/10.

2. The composition of claim 1, wherein the melt flow rate ranges from 0.1 to 100 g/10 min.

3. The composition of claim 1, wherein the nitrogen gas permeability is 0.7×10⁻¹⁰ cm3 (STP)·cm/cm2·sec·cmHg or less.

4. The composition of claim 1, wherein the perfluoro(alkyl vinyl ether) content of the copolymer (A) ranges from 3 to 20 wt %.

5. The composition of claim 1, wherein the melt flow rate of the copolymer (A) ranges from 0.01 to 100 g/10 min.

6. The composition of claim 1, wherein the melt flow rate of the polytetrafluoroethylene (B) is 1 g/10 min or greater.

7. The composition of claim 1, wherein the melt flow rate of the polytetrafluoroethylene (C) is 0.01 g/10 min or greater.

8. The composition of claim 1, wherein the weight ratio of A/(B+C) ranges from 80/20 to 40/60.

9. The composition of claim 8, wherein the weight ratio of A/(B+C) ranges from 80/20 to 50/50.

10. The composition of claims 1, wherein the weight ratio of A/(B+C) ranges from 99.9/0.1 to 95/5.

11. The composition of claim 1, wherein the melt processing is extrusion.

12. The composition of claim 1, wherein the melt processing is injection molding.

13. The composition of claim 1, wherein the melt processing is blow molding.

14. The composition of claim 1, wherein the melt processing is transfer molding.

15. The composition of claim 1, wherein the melt processing is rotation molding.

16. The composition of claim 1, wherein the melt processing is compression molding.
